(19) United States
(12) Patent Application Publication
(10) Pub. No.: US 2022/0245648 A1
(43) Pub. Date: Aug. 4, 2022

(54) ENTERPRISE DIGITAL CUSTOMER SEGMENTS FOR PRODUCTS AND SERVICES

(71) Applicant: T-Mobile USA, Inc., Bellevue, WA (US)

(72) Inventors: Sanjay KHARATE, Sammamish, WA (US); Andrea MATESSI, Sammamish, WA (US); Brian HOLSCLAW, Seattle, WA (US); Loren MILLER, Monroe, WA (US); Santosh PILLAI, Bothell, WA (US); Kristopher WILSON, Sammamish, WA (US)

(21) Appl. No.: 17/165,617

(22) Filed: Feb. 2, 2021

(51) Int. Cl. G06Q 30/00; G06F 9/54

(52) U.S. Cl. CPC G06Q 30/016; G06F 9/547

(57) ABSTRACT

An enterprise digital customer segmentation (EDCS) includes receiving a verification request from a customer service application. The verification request includes a subscriber identifier. In response to the verification request, supporting information is obtained. The supporting information is associated with the subscriber identifier from a data source via an application programming interface (API) service. A verification status is determined based at least on the supporting information. In response to determining that the verification status indicates that the supporting information is substantiated, one or more segments are associated with the supporting information, and the one or more segments are associated with the subscriber identifier.

### BACKGROUND

Customer segmentation or market segmentation is a division of customers in a given market into discrete groups. Such segmentation may be generally integrated with operations related to product recommendations, pricing, up-selling strategies, and other marketing efforts. Many organizations implement customer segmentation to improve their product and service offerings and customer experience. However, mechanisms for managing customer segments and discrete groups can be a resource-intensive process that can require coordination among multiple systems to provide regular verification. Additionally, the customer segmentation process typically requires the identification of key segment interactions and the identification of services to offer each segment that requires cross-platform coordination.

### BRIEF DESCRIPTION OF THE DRAWINGS

The detailed description is described with reference to the accompanying figures, in which the leftmost digit(s) of a reference number identifies the figure in which the reference number first appears. The use of the same reference numbers in different figures indicates similar or identical items.

FIG. 1 illustrates an example of a network architecture for managing market segments and performing verification of supporting information.

FIG. 2 is a block diagram showing various components of an illustrative computing device for managing market segments and performing verification of supporting information.

FIG. 3 is a flow diagram of an example process for processing verification requests for various market segments and determining verification status.

FIG. 4 is a flow diagram of an example process for managing market segments.

### DETAILED DESCRIPTION

This disclosure is generally directed to techniques for managing marketing segments that may be integrated with enterprise operations. Aspects of the disclosure are described with regard to implementing a framework for an enterprise digital customer segmentation (EDCS) which is configurable to provide verification and management of segment life cycle through registration, verification, approval, and expiration of segments. In one embodiment, the segments are provided at a customer account level, product/service level, promotion level, and customer level.

In some aspects, an EDCS server may communicate with one or more data sources to obtain supporting information in response to receiving verification requests from a customer service application. The customer service applications may be accessible from a user device that is operated by a customer or accessible from a customer service terminal that is operated by a customer service representative. The verification request may include a subscriber identifier that is associated with the customer and information that needs to be verified (e.g., whether a customer is a service member in the military). The EDCS server may verify the information based at least on the supporting information that may be obtained from one or more data sources. In one example, the data sources may include a customer account database that may be maintained by a wireless telecommunications provider. In other examples, the data sources may include third-party services that may work with the telecommunications provider such as a marketing service. If the supporting information is not available at one or more data sources, or updated supporting information is needed, the EDCS server may request the supporting information from the customer via the customer service application.

In some aspects, the EDCS server may identify a segment that is associated with the supporting information. For example, if the supporting information indicates that a customer is a service member of the military, then the EDCS server may identify a customer segment that corresponds to customers who are in the military and associate such customer segment with the subscriber identifier of the customer. The customer segment may be recorded in the customer account information file that is stored in the customer account database. In another example, the EDCS server may identify a product segment that is associated with the supporting information. Continuing with the above example, the EDCS server may identify a product segment that is associated with a product that is available for purchase only by customers that are in the military (i.e., customers that are associated with the customer segment indicating that the customer is in the military). The EDCS server may associate such a product segment with the subscriber identifier of the customer. The product segment may be provided to a marketing service, which in turn may send a targeted advertisement of the product that is associated with the product segment to the customer.

The EDCS server may perform re-verification periodically to determine whether a segment is still applicable to a customer. For example, the EDCS server may periodically verify whether a customer is still a service member in the military. More specifically, the EDCS server may retrieve the supporting information from a data source and review the supporting information or request updated supporting information via the customer service application. In some aspects, the EDCS server may also review the verification history that is associated with the verification request and the supporting information. If the EDCS server determines, based at least on the supporting information, that the customer is no longer a service member in the military, the EDCS server may remove the customer segment that indicates that the customer is in the military, thereby disassociating such customer segment with the subscriber identifier of the customer.

Similarly, the EDCS server may determine whether a segment is still applicable to a product or a service. For example, the EDCS server may determine whether a promotion segment that is associated with a promotion (e.g., sale, discount, coupon, voucher, credit) is still valid for a product or a service. If the promotion is still offered, but no longer valid for use with the product or the service, then the EDCS server may disassociate the promotion segment from the product or the service. Additionally, the EDCS server may periodically determine whether a segment is still valid. Continuing with the above example, if the promotion is expired, then the EDCS server may remove the promotion segment that is associated with the expired promotion. Conversely, new segments may be added at a customer account level, product/service level, promotion level, and customer level.

As the EDCS server continuously re-verifies supporting information and maintains segments at various levels (e.g., a customer account level, product/service level, promotion level, customer level, etc.), marketing segmentation is integrated with enterprise functions in a more orderly manner. The techniques described herein may be implemented in a number of ways. Example implementations are provided below with reference to the following figures.

### Example Network Architecture

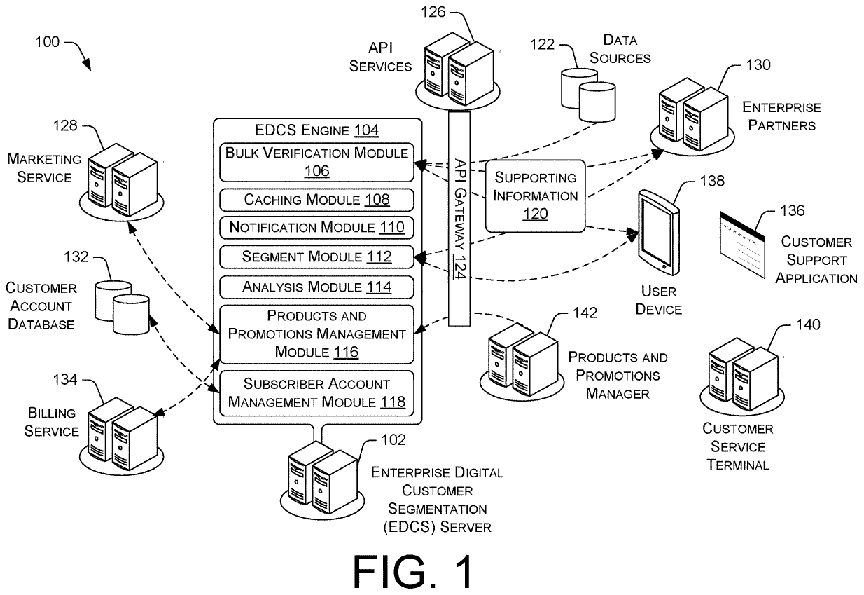

FIG. 1 illustrates an example architecture for implementing enterprise-wide customer segmentation. The network 100 can be a cellular network that implements 2G, 3G, 4G, 5G, and long-term evolution (LTE), LTE advanced, high-speed data packet access (HSDPA), evolved high-speed packet access (HSPA+), universal mobile telecommunication system (UMTS), code-division multiple access (CDMA), global system for mobile communications (GSM), a local area network (LAN), a wide area network (WAN), and/or a collection of networks (e.g., the Internet). Accordingly, the network 100 may include a plurality of hardware, software, and other infrastructure components that may be typical of a large wireless telecommunications provider.

The network 100 includes an EDCS server 102. The EDCS server 102 may include general-purpose computers, such as desktop computers, tablet computers, laptop computers, servers (e.g., on-premise servers), or other electronic devices that are capable of receiving input, processing the input, and generating output data. The EDCS server 102 may be operated by a wireless telecommunications provider or a third-party entity that is working with the wireless telecommunications provider. Although FIG. 1 illustrates a centralized EDCS server 102, EDCS server 102 may be distributed across multiple servers or computing devices. For example, the EDCS server 102 may be executed in a data center or cloud environment where multiple computing nodes are used to execute the functions described herein. Accordingly, the EDCS server 102 may provide data and processing redundancy, in which data processing and data storage may be scaled in response to demand. The EDCS server 102 can include a plurality of physical machines that may be grouped and presented as a single computing system. Each physical machine of the plurality of physical machines may comprise a node in a cluster. The EDCS server 102 may also be in the form of virtual machines, such as virtual engines (VE) and virtual private servers (VPS).

The EDCS server 102 may implement an EDCS engine 104. The EDCS engine 104 may be executable via one or more hardware, software, or communication environments, each of which enables the EDCS server 102 to manage market segments at a customer account level, product/service level, promotion level, and customer level. The EDCS engine 104 may also be configured to identify different segments and associate individual segments with customers, customer accounts, products, services, promotions, and/or so forth. Additionally, the EDCS engine 104 may associate one or more segments with subscriber identifiers such that various products, services, and promotions may be offered to respective customers.

In one example, the EDCS engine 104 may identify a customer segment based at least on a customer's demographic information (e.g., seniors, students, etc.). In another example, the EDCS engine 104 may identify an additional customer segment based at least on the customer's profession, employer, or association information (e.g., military personnel, first-responders, teachers, etc.). The EDCS engine 104 may also identify a product segment based on the product type (e.g., phones). Additionally, the EDCS engine 104 may identify a promotion segment based on the geographic region (e.g., sale, discount, coupon, voucher, or credit valid only in the United States).

In one embodiment, these functions may be controlled by different modules, such as a bulk verification module 106, a caching module 108, a notification module 110, a segment module 112, an analysis module 114, a products and promotions management module 116, and a subscriber account management module 118. The bulk verification module 106 may retrieve and verify newly available data such as supporting information 120 from one or more data sources 122. In one example, the supporting information 120 can include documents, data, or other information that is associated with a customer. In another example, the supporting information 120 can include documents, data, or other information (e.g., product/service description, specification, terms and conditions of a promotion, etc.) that is associated with a product, a service, or a promotion. The bulk verification module 106 may include a workflow scheduler that periodically checks for and retrieves newly available data from the data sources 122. In some aspects, the caching module 108 may store supporting information and other collected data in a data store. In some aspects, the EDCS server 102, via the bulk verification module 106 of the EDCS engine 104, may invoke an application programming interface (API) gateway 124, which may communicate with one or more API services 126 to perform one or more operations specified by data requests (i.e., for supporting information). Results of such operations performed by the API services 126 are sent as response messages to the EDCS server 102.

The API services 126 may also perform tasks such as authentication, SSL termination, rate limiting, logging and monitoring, response caching, and/or so forth. The API services 126 can be any API used to access services (e.g., marketing services 128, enterprise partners 130, billing services 134, etc.) and/or resources (e.g., the data sources 122, the customer account database 132, etc.). In the illustrated embodiment, the API services 126 may also be implemented as a web API or a web service such as a customer service application 136 that may be accessed via the user device 138 or a customer service terminal 140. In an embodiment, the API services 126 may implement Representational State Transfer (REST) APIs. A REST API may be accessible via a REST API client and configured to translate REST calls from client applications via the REST API.

The notification module 110 may report supporting information 120 to the various modules of the EDCS engine 104 such as the segment module 112 following data acquisition. The segment module 112 may be configured to identify segments for customers, products, services, and offers, and promotions. The segment module 112 may implement a rules engine that holds logical deduction rules that assist the analysis processes via an analysis module 114 to identify various segments (e.g., customer segments, product or service segments, and promotion segments). In some aspects, the segment module 112, via the rules engine, may determine that a customer belongs to one or more customer segments based at least on supporting information. For example, the supporting information may indicate that the customer may be military personnel and belong to a particular demographic.

Similarly, the segment module 112 may determine that a product may belong to one or more product segments. For example, the segment module 112 may determine a product may be a particular product type and associated with an original equipment manufacturer (OEM) based at least on supporting information. Additionally, the segment module 112 may determine that a product may belong to one or more promotion segments.

For example, a product may be on sale and eligible for an additional discount if purchased with a coupon. In some aspects, the segment module 112 may manage the lifecycle of a segment. In one example, a customer may qualify or disqualify for a customer segment over a period of time. For example, the segment module 112 may determine that a customer may be affiliated with an association only for a specific amount of time (e.g., one-year membership) based at least on the supporting information. When the customer is no longer affiliated with the association, then the segment module 112 may disassociate the customer from the respective customer segment. Similarly, the segment module 112 may determine that a promotion may be valid for a limited amount of time. In response to determining that a promotion is expired, the segment module 112 may invalidate the promotion segment that is associated with the promotion and removed the promotion segment.

The products and promotions management module 116 may maintain a list of product and service offerings. In one example, the products and promotions management module 116 may add new products and services to the list upon receiving the most up-to-date list of product and service offerings from the products and promotions manager 142. The products and promotions management module 116 may also remove from the list the products and services that are no longer offered. Additionally, the products and promotions management module 116 may receive valid promotions and discounts for one or more products and service offerings. The products and promotions management module 116 may manage the product or service segments and/or promotion segments for the individual product and service offerings.

The subscriber account management module 118 may be configured to manage the customer segments for individual customers. The individual customers may be associated with a subscriber account. The account information may be maintained in the customer account database 132. The subscriber account management module 118 may maintain supporting information and customer data locally or in the customer account database 132. In some embodiments, the subscriber account management module 118 may communicate with other data store and/or other data sources and store supporting information and customer data in a distributed storage system, in which data may be stored for long periods and replicated to guarantee reliability.

The subscriber account management module 118 may also be configured to identify customers associated with one or more customer segments that are eligible for product and service offerings and/or promotions that may be associated with one or more segments. For example, the subscriber account management module 118 may determine that a customer segment from a customer's account makes the customer eligible for a discount associated with an offer and promotion segment for a product associated with a product segment. In some aspects, the subscriber account management module 118 may implement the marketing services 128 to provide directed marketing to customers based at least on customer segments.

### Example Computing Device Components

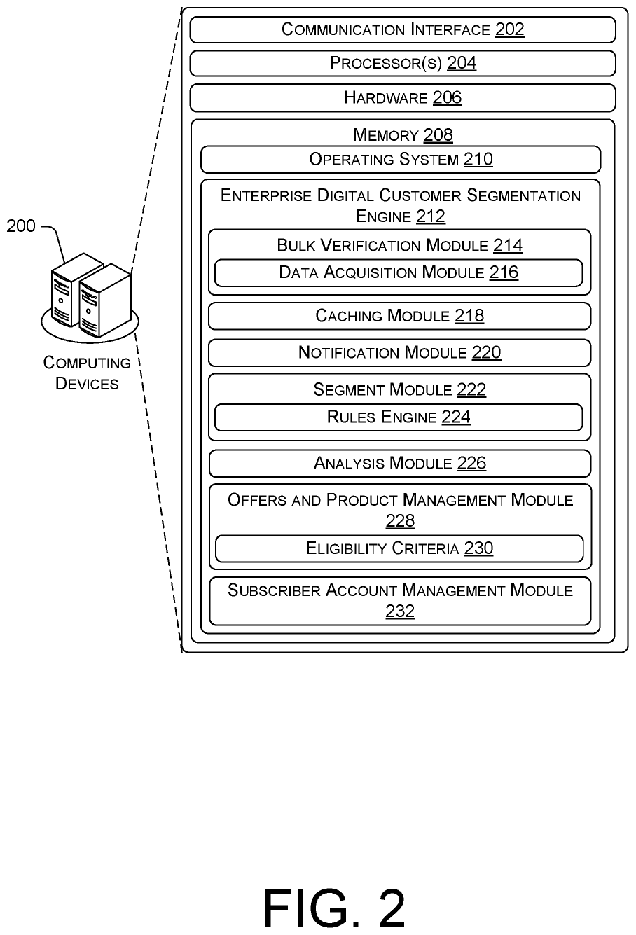

FIG. 2 is a block diagram showing various components of an illustrative computing device 200, wherein the computing device can comprise an EDCS server. It is noted that the EDCS server as described herein can operate with more or fewer of the components shown herein. Additionally, the EDCS server as shown herein or portions thereof can serve as a representation of one or more of the computing devices of the present system.

The EDCS server may include a communication interface 202, one or more processors 204, hardware 206, and memory 208. The communication interface 202 may include wireless and/or wired communication components that enable the EDCS server to transmit data to and receive data from other networked devices. In at least one example, the one or more processor(s) 204 may be a central processing unit(s) (CPU), graphics processing unit(s) (GPU), both a CPU and GPU or any other sort of processing unit(s). Each of the one or more processor(s) 204 may have numerous arithmetic logic units (ALUs) that perform arithmetic and logical operations as well as one or more control units (CUs) that extract instructions and stored content from processor cache memory, and then execute these instructions by calling on the ALUs, as necessary during program execution.

The one or more processor(s) 204 may also be responsible for executing all computer applications stored in the memory, which can be associated with common types of volatile (RAM) and/or nonvolatile (ROM) memory. The hardware 206 may include additional user interface, data communication, or data storage hardware. For example, the user interfaces may include a data output device (e.g., visual display, audio speakers), and one or more data input devices. The data input devices may include but are not limited to, combinations of one or more keypads, keyboards, mouse devices, touch screens that accept gestures, microphones, voice or speech recognition devices, and any other suitable devices.

The memory 208 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. The memory 208 may also include a firewall. In some embodiments, the firewall may be implemented as hardware 206 in the EDCS server.

The processor(s) 204 and the memory 208 of the EDCS server may implement an operating system 210 and an EDCS engine 212. The operating system 210 may be any operating system capable of managing computer hardware and software resources. For example, the operating system 210 may include components that enable the EDCS server to receive and transmit data via various interfaces (e.g., user controls, communication interface, and/or memory input/output devices), as well as process data using the processor(s) 204 to generate output. The operating system 210 may include a presentation component that presents the output (e.g., display the data on an electronic display, store the data in memory, transmit the data to another electronic device, etc.). Additionally, the operating system 210 may include other components that perform various additional functions generally associated with an operating system.

Execution of the EDCS engine 212 by the processor(s) 204 configures the EDCS server to perform various functions. For example, the EDCS engine 212 may be generally configured for generating segments and associating segments with customers, products and services, and/or promotions. The EDCS engine 212 may include modules, routines, program instructions, objects, and/or data structures that perform particular tasks or implement particular abstract data types. For example, the EDCS engine 212 may include a bulk verification module 214, a caching module 218, a notification module 220, a segment module 222, an analysis module 226, an products and promotions management module 228, and a subscriber account management module 232. The operating system 210 may be used to implement these modules.

The bulk verification module 214 may include one or more instructions which, when executed by the one or more processors 204, direct the computing devices 200 to perform operations related to retrieving and verifying supporting information from one or more data sources. The supporting information may be information that is associated with a customer. The supporting information may also be information that is associated with a product, service, and/or a promotion. In one aspect, the bulk verification module 214 includes a data acquisition module 216 to receive data from the various data sources represented in FIG. 1. The data acquisition module 216 may compile the data over a predetermined period. The data acquisition module 216 may include a workflow scheduler that periodically checks for and retrieves newly available data from data sources. In turn, the data sources may be responsible for retrieving the supporting information and other data. In one example, the supporting information and other data may be retrieved from a customer service application or other services (e.g., web services) via data push or data pull techniques. The workflow scheduler may handle the extraction and handling of the data based on configurable policies. For example, a configurable policy may specify the source data location, frequency of data retrieval, handling procedures for late arrival data, data retention period, and data disposal following the expiration of the data retention period. The handling procedures for the late arrival data may specify a predetermined cutoff period during which any data arriving late may be incorporated with data that is retrieved on time for processing.

In various embodiments, the data acquisition module 216 may employ file transfer protocol (FTP), Hypertext Transfer Protocol (HTTP) posts, direct network infrastructure element connection, and/or other data transfer techniques to obtain supporting information from the customer service application or other services. The supporting information may be in the form of input data files (i.e., JavaScript Object Notation [JSON] records), which are received from the customer service application or other services. In some embodiments, the data acquisition module 216 may perform data integrity tests to verify that the content of the received data files is not corrupt. The data acquisition module 216 may also use data adaptors to interface with the core network to collect supporting information from the data sources.

The data acquisition module 216 may implement a caching module 218 to store supporting information and other collected data. For instance, the caching module 218 may store supporting information and other collected data in the data store 234. The data store 234 may comprise a data management layer that includes software utilities for facilitating the acquisition, processing, storing, reporting, and analysis of data. The bulk verification module 214 may also include a notification module 220 and may report supporting information to the various modules of the EDCS engine 212 following data acquisition. For example, the notification module 220 may provide supporting information to the segment module 222. In another example, the notification module 220 may provide supporting information to the data store 234. Additionally, the notification module 220 may communicate with various data sources (e.g., user devices, enterprise partners, customer account database, etc.) and other services (e.g., marketing services, products and promotions manager, billing service, etc.). The notification module 220 may be used to trigger a subsequent refreshing of the data acquisition, caching, segmentation, or other tasks performed by the EDCS engine 212 at predetermined intervals or upon a trigger event.

The segment module 222 may include one or more instructions, which when executed by the one or more processors 204 direct the computing devices 200 to perform operations related to identifying segments for customers, products, services, and promotions. Accordingly, segmentation may occur at a customer level, customer account level, product/service level, and promotion level. Customer level segments can include certain types of customers such as military personnel, employ/company affiliation, partners, etc. Customer account level segments can include certain types of subscriber accounts that fall into one or more categories such as family accounts, employee accounts, etc. Product/service level segments can include certain types of user devices (e.g., iPhone, Samsung Galaxy, etc.) or subscription-based services (e.g., Netflix, streaming services, communication services). Promotion level segments can include certain types of discounts. The segment module 222 may maintain a list of the market segments filtered or selected based on specific rules or criteria. New segments may be added, and expired segments may be removed periodically. The list may be maintained in the data store 234 or a remote server.

Additionally, the segment module 222 may implement a rules engine 224 that holds logical deduction rules that assist the analysis processes via an analysis module 226 to identify various segments. These rules can be introduced by the end-users of the system during the configuration of the system. For example, rules for segmenting customers may be different from rules for segmenting products, services, and promotions. The rules engine 224 may constantly examine the system information against its stored rules, and when a rule's condition is met the rule engine performs actions associated with the rule.

The rule engine 224 may provide the users of the system an associated tool to define rules and to identify specific behavioral patterns based on various types of interaction and the interaction information captured. The rules can be adaptive and may change according to the results of the analysis. For example, a rule could search for an interaction that started with adding a user to a user account and was followed by changing a subscription plan from a single user plan to a family plan. Such rule, when met, suggests that a user account that is associated with multiple users may be eligible for a family plan. In another example, a rule is met when two conditions are met: a user account that signs up for a family plan allows each family plan member to use their user devices.

In some aspects, the analysis module 226 may analyze the supporting information to determine whether the supporting information indicates that a customer qualifies for a segment. Similarly, the analysis module 226 may analyze the supporting information to determine whether a product, a service, or a promotion qualifies the product, the service, or the promotion for a segment. In one example, the analysis module 226 may extract information from the supporting information that may describe a product. Accordingly, the analysis module 226 may analyze supporting information to determine whether one or more supporting information about the product qualifies the product for a segment. In various embodiments, the analysis module 226 may initiate retrieval of data (i.e., supporting information) from a data source via the data acquisition module 216. For instance, the analysis module 226 may initiate retrieval of additional data upon determining that the supporting information does not qualify a customer for a segment.

The products and promotions management module 228 may include one or more instructions, which when executed by the one or more processors 204 direct the computing devices 200 to perform operations related to managing products, services, and promotions offered by a service provider (e.g., wireless telecommunications provider, marketing service, etc.). Accordingly, the products and promotions management module 228 may provide an organizational function that tracks the development, launching, positioning, and pricing of various products and services. Additionally, the products and promotions management module 228 may be configured to provide marketing functions and manage various promotions that apply to different products and services.

In some aspects, the products and promotions management module 228 may maintain a list of products, services, and promotions offered. In one example, the products and promotions management module 228 may establish communications with a products and promotions manager. New products and services may be added, and existing products and services may be removed from the list upon receiving the most up-to-date product and service offerings from the products and promotions manager. Similarly, promotions for one or more products and service offerings may be added and removed. In some examples, the products and promotions management module 228 may activate and deactivate certain products, services, and promotions at predetermined periods.

The products and promotions management module 228 may manage the product segments, service segments, and/or promotion segments for the individual products, services, and promotions, respectively. The segments may be associated with eligibility criteria 230, which may be defined for individual products, services, and promotions. For example, eligibility criteria 230 for upgrading a product such as a user device may include 50% of the balance has been paid or after twelve months of purchase. In another example, eligibility criteria 230 for switching a plan for a subscription-based service may include fulfillment of a service agreement. The products and promotions management module 228 may update eligibility criteria 230 for the products, services, and promotions that are associated with a respective segment.

The subscriber account management module 232 may include one or more instructions, which when executed by the one or more processors 204 direct the computing devices 200 to perform operations related to managing the customer segments for individual customers and customer accounts for the customers. The subscriber account management module 232 may communicate with a customer account database to maintain account information. The subscriber account management module 232 may also maintain supporting information and customer data in the customer account database. In some embodiments, the subscriber account management module 232 may communicate with other data stores and/or other data sources and store supporting information and customer data in a distributed storage system. The subscriber account management module 232 may initiate retrieval of such supporting information and customer data for verification and reverification. Additionally, the subscriber account management module 232 may be configured to purge information when it occupies a large amount of space and is not needed anymore, or updated information is obtained.

The subscriber account management module 232 may also be configured to identify customers associated with one or more customer segments that are eligible for product and service and/or promotions that may be associated with one or more segments based at least on the eligibility criteria 230. For example, the subscriber account management module 232 may determine that a customer segment from a customer's account makes the customer eligible for a discount associated with a promotion segment for a product that is associated with a product segment. In some aspects, the subscriber account management module 232 may implement marketing services to provide directed marketing to customers based at least on one or more customer segments. For example, the marketing services may provide targeted advertisements to customers based at least on customer segments. In some aspects, the subscriber account management module 232 may also implement billing services, wherein the billing services may update billing information based at least on one or more products, services, and/or discounts that are associated with the customer account.

### Example Processes

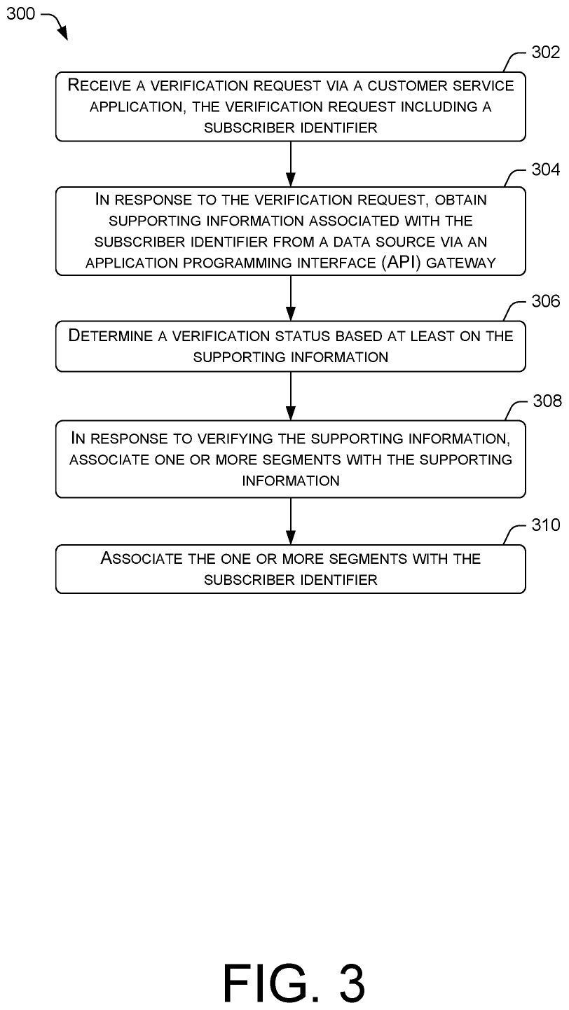

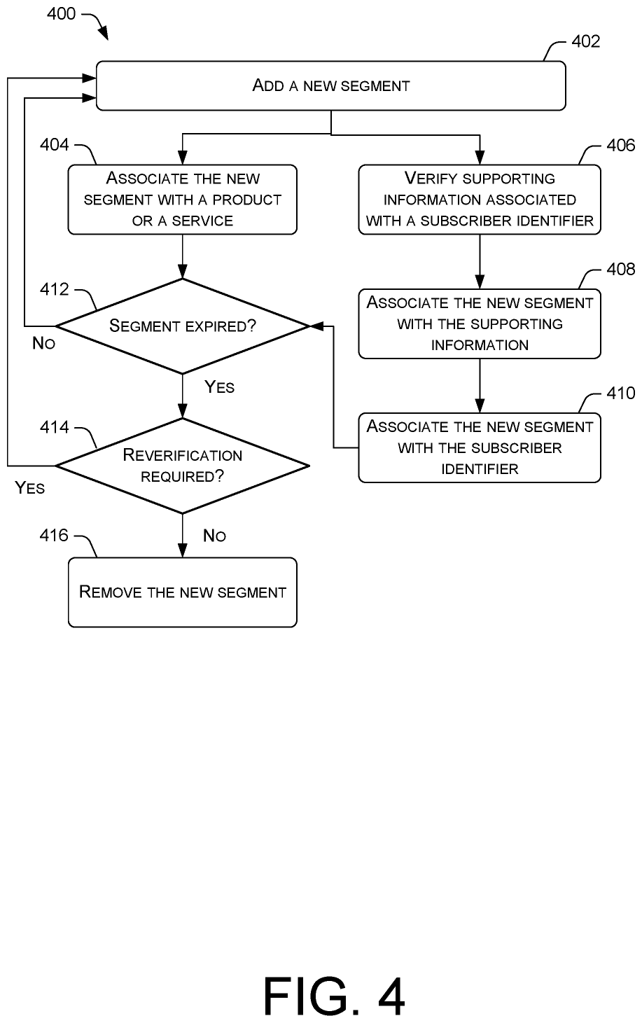

FIGS. 3 and 4 presents an illustrative process 300 for generating segments and associating segments with customers, products and services, and/or promotions. The processes 300 and 400 are illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, processes 300 and 400 are described with reference to FIGS. 1 and 2.

FIG. 3 is a flow diagram of an example process 300 for implementing customer segmentation. At block 302, an EDCS server may receive a verification request via a customer service application. The verification request may include a subscriber identifier that is associated with a customer. The verification request may indicate which document or what information needs to be verified. The customer service application may be accessible via a user device that is operated by the customer. Additionally, or alternatively, the customer service application may be accessible via a customer service terminal that is operated by a customer service representative. At block 304, in response to the verification request, the EDCS server may obtain supporting information associated with the subscriber identifier from a data source via an API gateway. In some aspects, the data source may be a data store that is managed by a wireless telecommunications provider or a third-party entity that is working with the wireless telecommunications provider, wherein the third-party entity may be authenticated. The data source may also be the customer.

At block 306, the EDCS server determines a verification status based at least on the supporting information. For example, the EDCS server may communicate with a military verification service to verify that a customer is in the military. At block 308, in response to verifying the supporting information, the EDCS server may associate one or more segments with the supporting information. The segments may include at least one of a customer account segment and a customer segment. For instance, the customer segment may include a segment for customers in the military. Accordingly, the customer segment may be associated with supporting information indicating that the customer is in the military. In other examples, the segments may include product or service segments and promotion segments. The EDCS server may associate promotion segments that are associated with promotions eligible for customers in the military. At block 310, the EDCS server may associate one or more segments with the subscriber identifier. Accordingly, the segment for customers in the military may be associated with the subscriber identifier that is associated with the customer. The EDCS server may notify the verification status via the customer service application.

FIG. 4 is a flow diagram of an example process 400 for managing customer segmentation. At block 402, an EDCS server may add a new segment. The new segment may be associated with at least one product or service, promotions, customer account, and customer. New segments may be added when a new product, service, or promotion is offered. Additionally, new segments may be added in response to new rules. At block 404, the EDCS server may associate the new segment with a product or a service. The EDCS server may also associate the new segment with an offer or a discount. The EDCS server may concurrently verify or re-verify supporting information that is associated with a subscriber identifier, as indicated in block 406. If the verification status fails, the EDCS server may request supporting information associated with the subscriber identifier of a customer. If the supporting information is verified, the EDCS server may associate the new segment with the supporting information, as indicated in block 408. The verification status may be updated based at least on the verification or periodic re-verification.

At block 410, the EDCS server may associate the new segment with the subscriber identifier. At decision block 412, the EDCS server determines whether a segment expired. In one example, a segment for a promotion may be valid only for a predetermined period. If the segment is expired (“yes” from decision block 412), the EDCS server determines whether reverification is required as indicated in decision block 414. If the reverification is not required (“no” from decision block 414), the EDCS server removes the expired segment, as indicated in block 416. If the expired segment is associated with a product, service, promotion, customer account, or a customer, the EDCS server may disassociate the expired segment at the respective customer account level, product/service level, promotion level, and customer level. For example, the EDCS server may disassociate the segment from the supporting information and the subscriber identifier. If the segment is not expired (“no” from decision block 412), or reverification is required (“yes” from decision block 414), the EDCS server continues the process in blocks 402 through 416.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more non-transitory computer-readable media storing computer-executable instructions that upon execution cause one or more processors to perform acts comprising:
receiving a verification request via a customer service application, the verification request including a subscriber identifier;
in response to the verification request, obtaining supporting information associated with the subscriber identifier from a data source via an application programming interface (API) service;
determining a verification status based at least on the supporting information;
in response to verifying the supporting information, associating one or more segments with the supporting information; and
associating the one or more segments with the subscriber identifier.

2. The one or more non-transitory computer-readable media of claim 1, wherein the one or more segments include at least one of a customer account segment and a customer segment.

3. The one or more non-transitory computer-readable media of claim 1, wherein the acts further comprise:
notifying the verification status via the customer service application.

4. The one or more non-transitory computer-readable media of claim 1, wherein the acts further comprise:
periodically re-verify the supporting information; and
updating the verification status based at least on the periodic re-verification.

5. The one or more non-transitory computer-readable media of claim 1, wherein the acts further comprise:
requesting additional supporting information via the customer service application;
receiving the additional supporting information via the customer service application;
determining the verification status based at least on the additional supporting information;
in response to verifying the additional supporting information, associating the one or more segments with the additional supporting information; and
associating the one or more segments with the subscriber identifier.

6. The one or more non-transitory computer-readable media of claim 1, wherein the acts further comprise:
generating a verification event, the verification event including the verification status.

7. The one or more non-transitory computer-readable media of claim 1, wherein the acts further comprise:
receiving an additional verification request via the customer service application, the additional verification request including the subscriber identifier;
obtaining a verification history associated with the subscriber identifier; and
determining the verification status based at least on the verification history.

8. A computer-implemented method, comprising:
receiving, at one or more servers, a verification request via a customer service application, the verification request including a subscriber identifier;
in response to the verification request, obtaining, via the one or more servers, supporting information associated with the subscriber identifier from a data source via an application programming interface (API) service;
determining, at the one or more servers, a verification status based at least on the supporting information;
in response to verifying the supporting information, associating, via the one or more servers, one or more segments with the supporting information; and
associating, at the one or more servers, the one or more segments with the subscriber identifier.

9. The computer-implemented method of claim 8, wherein the one or more segments include at least one of a customer account segment and a customer segment.

10. The computer-implemented method of claim 8, further comprising:
notifying the verification status via the customer service application.

11. The computer-implemented method of claim 8, further comprising:
periodically re-verify the supporting information at the one or more servers; and
updating, at the one or more servers, the verification status based at least on the periodic re-verification.

12. The computer-implemented method of claim 8, further comprising:
requesting additional supporting information via the customer service application;
receiving, at the one or more servers, the additional supporting information via the customer service application;
determining, at the one or more servers, the verification status based at least on the additional supporting information;
in response to verifying the additional supporting information, associating, at the one or more servers, the one or more segments with the additional supporting information; and
associating, at the one or more servers, the one or more segments with the subscriber identifier.

13. The computer-implemented method of claim 8, further comprising:
generating, via the one or more servers, a verification event, the verification event including the verification status.

14. The computer-implemented method of claim 8, further comprising:
receiving, at the one or more servers, an additional verification request via the customer service application, the additional verification request including the subscriber identifier;
obtaining, via the one or more servers, a verification history associated with the subscriber identifier; and
determining, at the one or more servers, the verification status based at least on the verification history.

15. A system, comprising:
one or more non-transitory storage mediums configured to provide stored computer-readable instructions, the one or more non-transitory storage mediums coupled to one or more processors, the one or more processors configured to execute the computer-readable instructions to cause the one or more processors to:
receive a verification request via a customer service application, the verification request including a subscriber identifier;
in response to the verification request, obtain supporting information associated with the subscriber identifier from a data source via an application programming interface (API) service;
determine a verification status based at least on the supporting information;
in response to verifying the supporting information, associate one or more segments with the supporting information; and
associate the one or more segments with the subscriber identifier.

16. The system of claim 15, wherein the one or more processors are further configured to:
add a new segment, the new segment associated with a customer account segment or a customer segment.

17. The system of claim 16, wherein the one or more processors are further configured to:
periodically re-verify the supporting information;
update the verification status based at least on the periodic re-verification;
associate the new segment with the supporting information; and
associate the new segment with the subscriber identifier.

18. The system of claim 15, wherein the one or more processors are further configured to:
determine whether at least one of the one or more segments is an expired segment;
remove an expired segment, the expired segment associated with a customer account segment or a customer segment;
disassociate the expired segment from the supporting information; and
disassociate the expired segment from the subscriber identifier.

19. The system of claim 15, wherein the one or more processors are further configured to:
generate a verification event, the verification event including the verification status.

20. The system of claim 15, wherein the one or more processors are further configured to:
receive an additional verification request via the customer service application, the additional verification request including the subscriber identifier;
obtain a verification history associated with the subscriber identifier; and
determine the verification status based at least on the verification history.
